(19) United States
(12) Patent Application Publication
(10) Pub. No.: US 2005/0118007 A1
(43) Pub. Date: Jun. 2, 2005

(54) Apparatus for moving containers

(75) Inventor: Antonio Bonita, Capannori (Lucca) (IT)

Correspondence Address: ARENT FOX KINTNER PLOTKIN & KAHN, 1050 CONNECTICUT AVENUE, N.W., SUITE 400, WASHINGTON, DC, 20036, US

(73) Assignee: VIMA IMPIANTI S.r.l.

(21) Appl. No.: 10/995,393

(22) Filed: Nov. 24, 2004

(30) Foreign Application Priority Data
Nov. 28, 2003 (IT) BO2003A000724

(51) Int. Cl. B65F 9/00

(52) U.S. Cl. 414/498

(57) ABSTRACT

The apparatus for moving containers equipped with a supporting frame comprises a fixed structure, a mobile body rotatably connected to the fixed structure, a plurality of elements projecting from the mobile body, these projecting elements being designed to engage with respective housings made in the container supporting frame.

### BACKGROUND OF THE INVENTION

The present invention relates to an apparatus for moving containers.

In particular, the present invention relates to an apparatus for moving containers for use in the pharmaceutical and/or chemical and/or food industry, the containers holding loose material consisting of powders, fine-grained pellets or similar products.

Said containers are normally very large and have a symmetrical shape.

Such containers are moved in order to mix the substances of which the afore-mentioned material is composed so that, at the end of this operation, the material has the required level of homogenization.

Moving apparatuses are known which comprise a mobile part that normally has a framework to which the container is fixed, and motor means designed to move the mobile part. Rotation of the mobile part consequently involves rotation of the container, normally about a respective axis which is set at an angle to the axis of symmetry.

The known apparatuses are not particularly efficient, both due to the complexity of the elements of which they are composed and the consequent difficulties involved in locking the containers to them.

In particular, significant disadvantages are encountered when using such moving apparatuses, in the operations for locking the containers to and releasing them from the respective mobile parts of the apparatuses.

Such operations are complicated and, at the same time, the locking achieved does not always meet the necessary safety requirements.

### SUMMARY OF THE INVENTION

The aim of the present invention is to provide an apparatus for moving containers which overcomes the above-mentioned disadvantages and which is, at the same time, functional, simple and economical to produce and practical and effective to use.

The technical features of the present invention, in accordance with the above-mentioned aim, are set out in the claims herein, in particular claim 1 and, preferably, any of the claims directly or indirectly dependent on claim 1.

### BRIEF DESCRIPTION OF THE DRAWINGS

The advantages of the present invention are more clearly described in the detailed description below, with reference to the accompanying drawings, which illustrate preferred embodiments of the invention, without limiting the scope of its application, and in which:

FIG. 1 is a perspective top view of an apparatus for moving containers made according to the present invention;

FIG. 2 is a perspective top view of a container designed to be moved by the apparatus illustrated in FIG. 1;

FIG. 3 is a schematic side elevation, with some parts in cross-section and other parts cut away for greater clarity, of a detail of a first embodiment of the apparatus illustrated in FIG. 1;

FIG. 4 is a top plan view, with some parts in cross-section and other parts cut away for greater clarity, of the detail illustrated in FIG. 3;

FIG. 5 is a schematic front elevation, with some parts transparent and other parts cut away for greater clarity, of the detail illustrated in the previous FIGS. 3 and 4;

FIG. 6 is a schematic side elevation, with some parts in cross-section, of a portion of the detail illustrated in the previous figures from 3 to 5;

FIGS. 7 and 8 are two schematic views, respectively a side and a front elevation, of a second embodiment of a detail of the apparatus illustrated in the previous figures.

### DESCRIPTION OF THE PREFERRED EMBODIMENTS

With reference to the accompanying drawings, the numeral 1 denotes as a whole a first embodiment of the apparatus for moving containers 2.

The containers 2 are of the known type and are normally used to hold loose materials in the pharmaceutical and/or chemical and/or food sector.

As illustrated in FIG. 2, the container 2 is mounted on a respective supporting frame 3 with a quadrangular base and comprising four vertical uprights 4 forming four respective faces, their lower ends fitted with wheels 5 designed for container transportation.

At one of the above-mentioned faces, referred to as the front face and labeled 6, the frame 3 comprises two parallel crosspieces 7, 8, respectively upper and lower, connecting two adjacent uprights 4.

Again with reference to FIG. 2, the upper crosspiece 7 has two holes 9 holes distanced from one another, whilst the lower crosspiece 8 has a hole 10 at the center of the crosspiece 8.

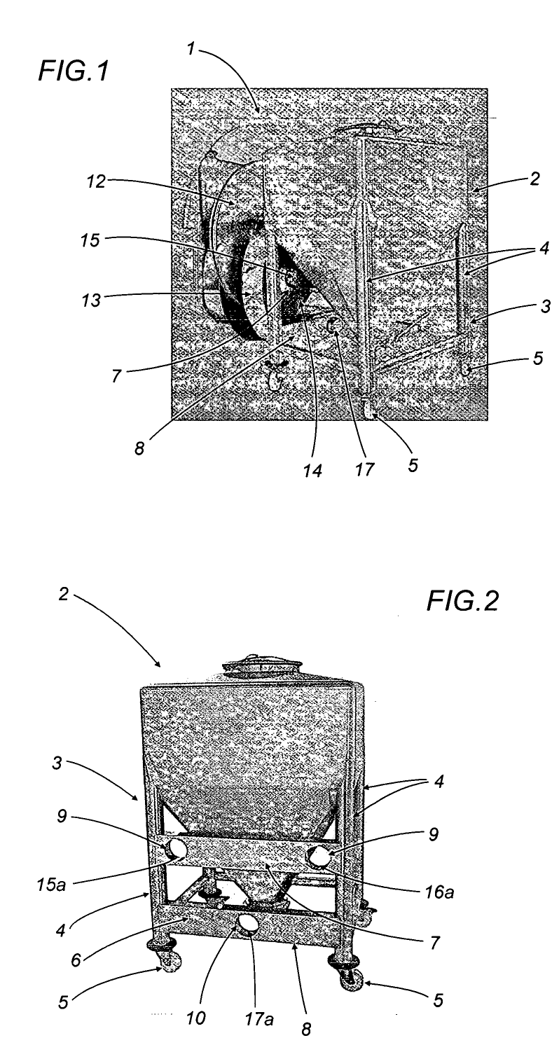

As illustrated in FIG. 1, the moving apparatus 1 is installed, advantageously but without limiting the scope of the application, on a wall 11 and comprises a fixed structure 12, integral with the wall 11, and a mobile body 13 which is rotatably connected to the fixed structure 12 in such a way that it rotates about a respective axis of rotation A.

In particular, in the embodiment described, the mobile body 13 has a first, front face 14 and a second, rear face opposite the fixed structure 12 and not illustrated in the accompanying drawings.

The apparatus 1 comprises first motor means, of the substantially known type and not illustrated, designed to move the mobile body 13 relative to the fixed structure 12.

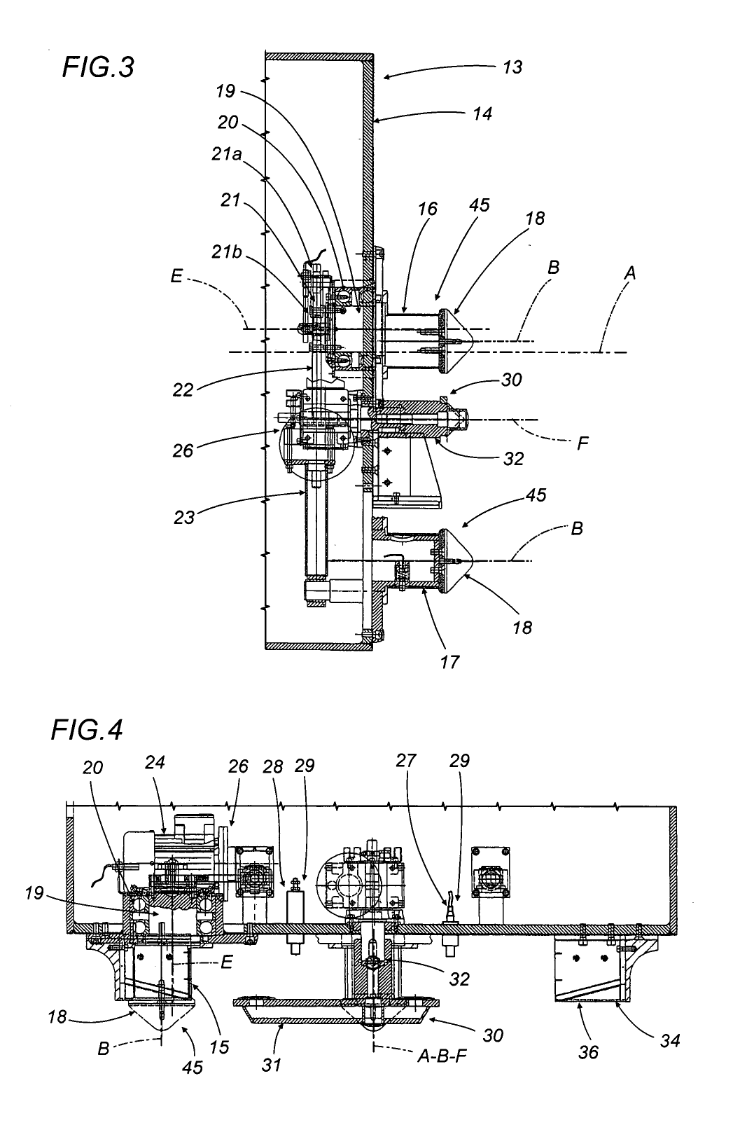

As illustrated in FIGS. 3, 4 and 5, on the mobile body 13 there are three projecting elements 15, 16, 17 designed to engage with respective housings 15a, 16a, 17a formed by the holes 9, 10 in the crosspieces 7, 8 of the container 2 supporting frame 3.

The projecting elements 15, 16, 17 have a substantially cylindrical shape with a first central axis of extension B and have a tapered end 18 to facilitate insertion of the element 15, 16, 17 in the respective housing 15a, 16a, 17a.

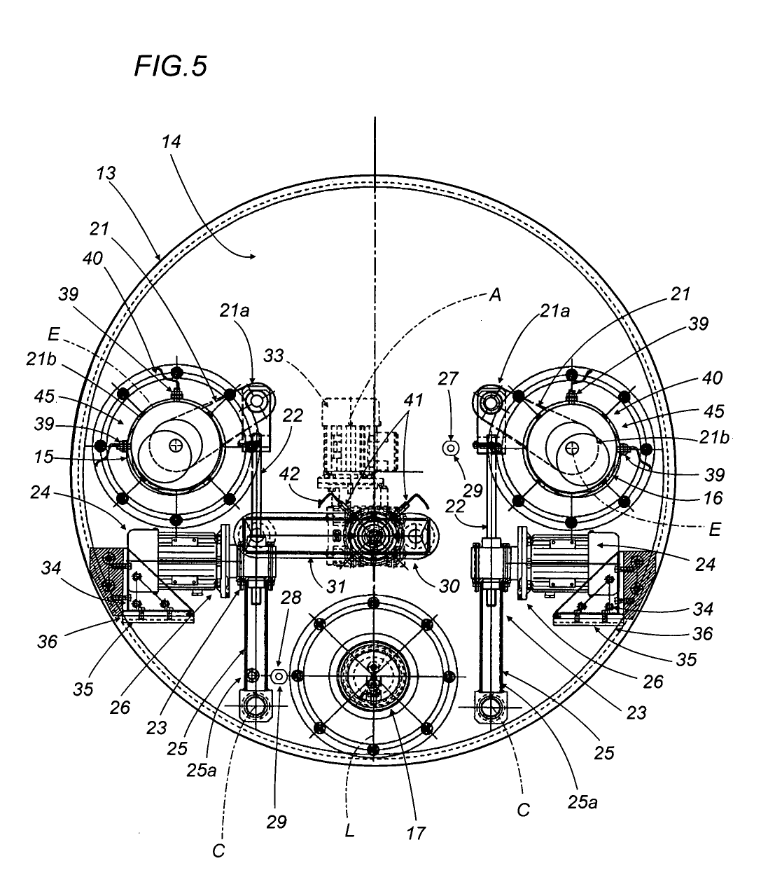

Of the three projecting elements 15, 16, 17, the lower element 17 in FIG. 5 is fixed whilst the upper elements 15, 16 in FIG. 5 are mobile, rotating about a second, eccentric axis E, parallel with the first, central axis B.

Therefore, the mobile projecting elements 15, 16 rotate about the second, eccentric axis E in order to move between a first position, illustrated in FIG. 1, in which they are centered in the respective housings 15a, 16a, and a second position, not illustrated, in which they are locked relative to the housing 15a, 16a.

As illustrated in FIGS. 3 and 4, the mobile projecting elements 15, 16 are eccentrically connected to respective shafts 19 coaxial with the second, eccentric axis E and supported by respective bearings 20 of the known type.

A first end 21a of a lever 21 is rigidly connected to each shaft 19, therefore also pivoting at the second, eccentric axis E.

Each lever 21 comprises a second end 21b longitudinally opposite the first end 21a. This second end 21b is connected to a mobile rod 22 of a jack 23 of the known type, driven by an electric motor 24.

The jack 23 also comprises a tube 25 in which the rod 22 runs. One end 25a of the tube 25 pivots at the mobile body 13 so that it oscillates about a respective axis C.

Any longitudinal movement by the jack 23 rod 22 causes a corresponding rotation of the lever 21 about the pivoting axis formed by the second, eccentric axis E.

The lever 21, the jack 23 and the electric motor 24 together form actuator means 26 driving each of the mobile projecting elements 15, 16 between their centering and locking positions.

As illustrated in FIG. 5, on its first, front face 14, the mobile body 13 has two first presence sensors 27, 28 respectively positioned at zones of the mobile body 13 close to the projecting elements 16, 17 and designed to face the upper and lower crosspieces 7, 8 of the container 2 supporting frame 3.

With reference to FIG. 5, the first face 14 of the mobile body 13 has a circular and substantially symmetrical shape relative to a plane whose line L in the plane illustrated passes through the axis of rotation A of the body 13 and through the central axis B of the fixed projecting element 17.

The two first presence sensors 27, 28 are located on opposite sides of said line L.

Therefore, advantageously, the layout of the first presence sensors 27, 28 is such that it guarantees, with just two sensors 27, 28, that the presence and correct positioning of both crosspieces 7, 8 close to the mobile body 13 will be indicated.

The first sensors 27, 28 form, for the apparatus 1, first detector means 29, which detect the closeness of the container 2 to the mobile body 13.

With reference to FIGS. 4 and 5, the apparatus 1 comprises a safety part 30 designed to engage with the crosspieces 7, 8 in ways that are not illustrated.

The safety part 30 comprises an engagement element 31, having an extended shape, fixed to one end of a shaft 32 projecting cantilever-style from the first, front face 14 of the mobile body 13.

The safety part 30 also comprises an actuator motor 33 designed to rotate the shaft 32 about a respective axis F to move the engagement element 31 between a first, inactive configuration, illustrated in FIGS. 4 and 5, in which the crosspieces 7, 8 can be brought alongside the first face 14 of the mobile body 13, and a second, operating configuration, not illustrated, in which the element 31 is designed to exercise a retaining action on the crosspieces 7, 8.

In practice, with reference to FIG. 5 and starting with the configuration of the engagement element 31 illustrated in it, the element 31 is substantially rotated through approximately 90°0 to reach the afore-mentioned second, operating configuration, not illustrated, in which it exercises a retaining action on the crosspieces 7, 8.

As illustrated in FIGS. 4 and 5, the apparatus 1 also comprises two contact elements 34, fixed on the first, front face 14 of the mobile body 13 and projecting from the latter to engage in contact with the lower crosspiece 8, at least in one container 2 movement step.

Each contact element 34 comprises a portion 35 made of a material with a high friction coefficient, the portion 35 designed to engage with a respective portion of the crosspiece 8 so as to guarantee an improved, more stable contact with the crosspiece 8.

For the apparatus 1 the contact elements 34 form means 36 by which the supporting frame 3 makes contact with the mobile body 13.

An alternative embodiment of the above-mentioned actuator means 26 for the mobile projecting elements 15, 16 is illustrated in FIGS. 7, 8.

In this alternative embodiment, the actuator means 26 comprise, for each mobile projecting element 15, 16, an electric motor 37 operatively connected to the respective projecting element 15, 16 by a coupling 38 of the gear wheel—worm screw type. This coupling, of the known type and therefore not illustrated in detail, consists of a gear wheel keyed on a portion 19a of the shaft 19 eccentrically connected to the projecting element 15, 16, and of a worm screw, also not illustrated, which is integral with the motor output shaft.

As illustrated in FIGS. 5 and 8 and with reference to both of the embodiments of the actuator means 26 for the mobile projecting elements 15, 16 described above, the apparatus 1 comprises two first position sensors 39, of the known type and not described in further detail, connected in such a way that they are integral with the mobile body 13 and set at an angular distance from the second, eccentric axis E to detect the angular positions assumed by the mobile projecting elements 15, 16 relative to the second, eccentric axis E.

The apparatus 1 also comprises, for each electric motor 24, 37 designed to move a mobile projecting element 15, 16, a circuit-breaker, not illustrated, designed to stop movement of the projecting element 15, 16 when the latter reaches its second position, in which it is locked relative to the housing 15a, 16a.

Advantageously, said stopping circuit-breaker is an amperometric relay acting on the electric motor 24, 37 to stop motor 24, 37 operation when it exceeds a predetermined electrical current absorption level.

The first position sensors 39 and stopping circuit-breaker form, as a whole, second detector means 40, for detecting when the mobile projecting element 15, 16 reaches the second, locking position.

As illustrated in FIG. 5, the apparatus 1 comprises two second position sensors 41, of the known type and not described in further detail, connected in such a way that they are integral with the mobile body 13 and set at an angular distance from the axis F to detect the angular positions assumed by the safety part 30.

In particular, the two second sensors 41 are designed to detect, respectively, when the engagement element 31 reaches the first, inactive configuration and the second, operating configuration.

The second position sensors 41 form third detector means 42 for the apparatus 1.

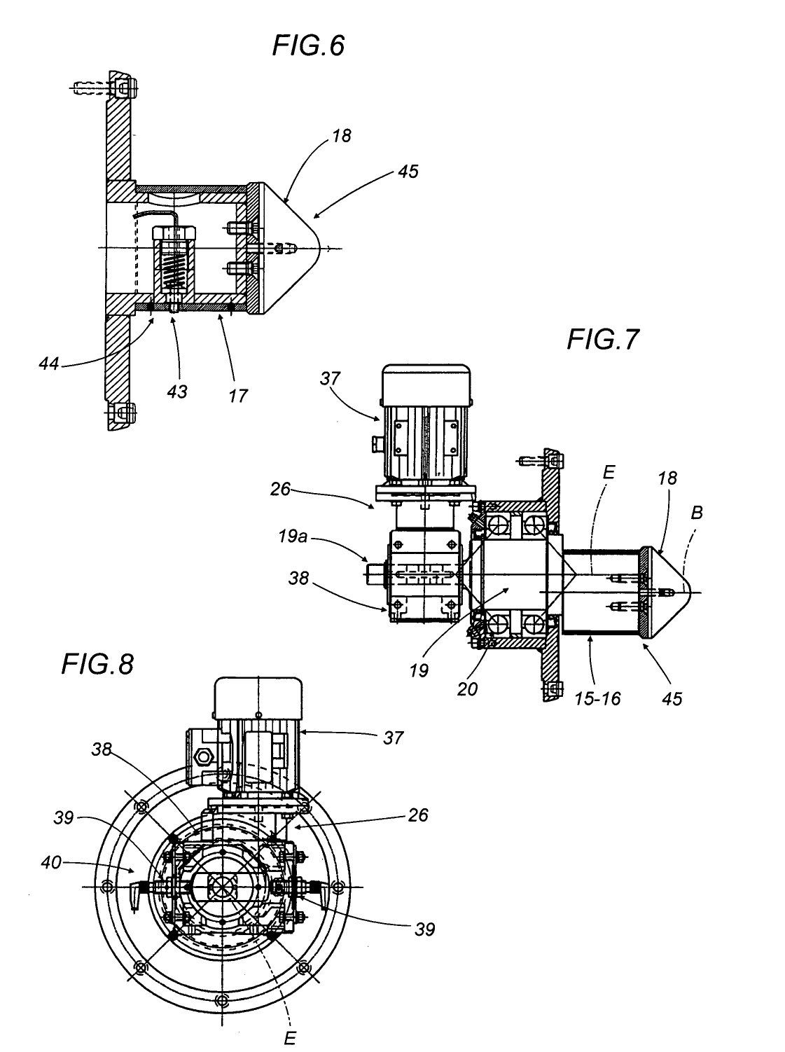

As illustrated in FIG. 6, on the fixed projecting element 17 there is a second presence sensor 43, designed to engage with a wall of the respective housing 17a to indicate the presence of the projecting element 17 in the housing 17a.

The second presence sensor 43 forms fourth detector means 44 for the apparatus 1.

The projecting elements 15, 16, 17 form means 45 for locking the container 2 to the mobile body 13 for the apparatus 1.

In practice, the container 2 is brought close to the apparatus 1 taking advantage of the fact that the wheels 5 of the frame 3 run on the ground and with the front face 6 of the frame opposite the first, front face 14 of the mobile body 13.

Taking advantage of the tapered shape of the ends 18 of the projecting elements 15, 16, 17, the latter, in the first, centering position, are inserted in the respective housings 15a, 16a, 17a formed by the holes 9, 10 in the crosspieces 7, 8.

The first presence sensors 27, 28 detect when the frame 3 has been brought alongside the mobile body 13, whilst the second presence sensor 43 located on the fixed projecting element 17 indicates when said element 17 has been inserted in the respective housing 17a.

Advantageously, these indications also signal that the mobile projecting elements 15, 16 are correctly inserted in the respective housings 15a, 16a, since otherwise the front face 6 of the frame 3 could not be alongside the first front face 14 of the mobile body 13.

With reference to the first embodiment of the actuator means 26 illustrated in FIGS. 3, 4 and 5, the electric motors 24 of the jacks 23 are activated so that they rotate the respective levers 21 about their pivoting axes formed by the second, eccentric axis E for each mobile projecting element 15, 16.

Rotation of the lever 21 results in the simultaneous rotation of the shaft 19 about the respective second, eccentric axis E and, therefore, moves the mobile projecting element 15, 16 away from its first, centering position.

Following eccentric rotation about the second axis E, each of the two mobile projecting elements 15, 16 rests on the wall of the respective housing 15a, 16a, that is to say, on the edge of the hole 9 forming the housing 15a, 16a.

The second of the two first position sensors 39 for each mobile projecting element 15, 16 detects that the element 15, 16 has reached its second, locking position.

At this point the jack motor 24 continues to use the lever 21 to force rotation of the shaft 19 and the mobile projecting element 15, 16 until the amperometric relay automatically interrupts the electrical power supply when a predetermined level of current absorption is reached.

This situation guarantees secure container 2 locking to the mobile body 13.

Once locking of the mobile projecting elements 15, 16 to the respective housings 15a, 16a is complete, the safety part 30 is made operative by activation of the relative actuator motor 33.

In other words, the shaft 32 is made to rotate, about the axis F, so that the engagement element 31 passes from its first, inactive configuration, in which the frame crosspieces 7, 8 can be brought alongside the mobile body 13, to its second, operating configuration, in which the safety part 30 is designed to exercise a geometric retaining action on the crosspieces 7, 8.

The second position sensors 41 indicate when the two configurations of the engagement element 31 have been reached.

With reference to the second embodiment of the actuator means 26 illustrated in FIGS. 7 and 8, from the moment when the projecting elements 15, 16, 17 have been inserted in the relative housings 15a, 16a, 17a, their operation differs from that just described exclusively in terms of the different mechanisms used to transfer motion from the electric motor 37 to the shaft 19 integral with the mobile projecting element 15, 16.

In this second embodiment, with the gear wheel-worm screw coupling 38, after activation of the electric motor 37, rotation is transmitted from the worm screw to the gear wheel keyed to the portion 19a of the shaft 19 and from the latter to the mobile projecting element 15, 16 integral with it.

Advantageously, this second embodiment is more suitable for smaller, lighter containers 2, whilst the first embodiment of the actuator means 26 is easily usable with containers 2 which may even be large and heavy, since it can apply high torques for locking the elements 15, 16 in the respective housings 15a, 16a.

Subsequent apparatus 1 operation for moving the container 2 is as in known processes and therefore not described in detail in this text.

Similarly, this text does not provide a description of the steps for releasing and detaching the container 2 at the end of its movement, since these may be directly deduced from the locking steps described above.

The apparatus 1 disclosed therefore advantageously allows a container 2 to be locked to the mobile body 13 in a secure, simplified and effective way, without the need for bulky and complex outer structures.

Another obvious advantage of the present invention is, therefore, that linked to the extreme limitation on parts projecting from the moving apparatus, since such parts, in sectors such as those of the pharmaceutical or chemical or food industry, require continuous cleaning and therefore take up a lot of time.

The invention described is suitable for evident industrial applications and may be subject to modifications and variations without thereby departing from the scope of the inventive concept. Moreover, all details of the invention may be substituted by technically equivalent elements.

1) an apparatus for moving containers which have a supporting frame, in particular in the pharmaceutical and/or chemical and/or food sector, comprising:
a fixed structure,
a mobile body rotatably connected to the fixed structure,
first motor means for moving the mobile body relative to the fixed structure,
means for locking the container to the mobile body comprising a plurality of elements projecting from the mobile body, the projecting elements being designed to engage with respective housings in the container supporting frame, wherein at least one of the projecting elements is mobile between a first position in which it is centered in the housing and a second position in which it is locked relative to the housing.

2) The apparatus according to claim 1, wherein the mobile projecting element, of which there is at least one, has a first, central axis of extension and can rotate about a second, eccentric axis, parallel with the first, central axis, allowing it to move between said first and second positions.

3) The apparatus according to claim 2, wherein it comprises actuator means for driving the movement of the mobile projecting element between its first and second positions.

4) The apparatus according to claim 3, wherein the actuator means comprise a lever rigidly connected to the projecting element and pivoting at the second, eccentric axis.

5) The apparatus according to claim 4, wherein the actuator means comprise a jack connected to the lever and designed to cause the lever to rotate about the second, eccentric axis.

6) The apparatus according to claim 5, wherein the jack comprises an electric actuator motor.

7) The apparatus according to claim 3, wherein the actuator means comprise an electric motor operatively connected to the projecting element by a coupling of the gear wheel—worm screw type, said gear wheel being keyed to a shaft which is rigidly connected to the projecting element coaxially with the second, eccentric axis.

8) The apparatus according to claim 1, in which the container supporting frame comprises at least one crosspiece, wherein the housings for the projecting elements are at least partly made in the crosspiece.

9) The apparatus according to claim 1, wherein it comprises first detector means for detecting the closeness of the container to the mobile body.

10) The apparatus according to claim 9, wherein the first detector means comprise at least a first presence sensor located on the mobile body and designed to indicate the presence of the container close to the mobile body.

11) The apparatus according to claim 9, wherein it comprises second detector means for detecting when the mobile projecting element, of which there is at least one, reaches the second, locking position relative to the housing.

12) The apparatus according to claim 11, wherein the second detector means comprise at least a first position sensor located on the mobile body and designed to detect the position of the mobile projecting element.

13) The apparatus according to claim 11 or 12, wherein the second detector means comprise at least one circuit-breaker for stopping the mobile projecting element when the element reaches its second, locking position relative to the housing.

14) The apparatus according to claim 6 or 7, wherein it comprises second detector means for detecting when the mobile projecting element, of which there is at least one, reaches the second, locking position relative to the housing, the second detector means comprising at least a first position sensor located on the mobile body and designed to detect the position of the mobile projecting element, and at least one circuit-breaker for stopping the mobile projecting element when the element reaches its second, locking position relative to the housing, the stopping circuit-breaker being an amperometric relay acting on the electric motor.

15) The apparatus according to claim 9, in which the container supporting frame comprises at least one crosspiece, wherein the housings for the projecting elements are at least partly made in the crosspiece, and wherein the locking means comprise a safety part designed to engage with the crosspiece, of which there is at least one, of the container supporting frame, the part being mobile at least between a first, inactive configuration in which the frame can be brought alongside the mobile body and a second, operating configuration, in which the safety part exercises a retaining action on the frame.

16) The apparatus according to claim 15, wherein the safety part comprises an engagement element having an extended shape, a shaft projecting from the mobile body and on the end of which the engagement element is fixed, an actuator motor designed to make the shaft rotate about a central axis to move the engagement element between its first and second configurations.

17) The apparatus according to claim 15 or 16, wherein it comprises third detector means for detecting at least when the mobile safety part reaches the second, operating configuration.

18) The apparatus according to claim 17, wherein the third detector means comprise at least a second position sensor designed to detect the position of the mobile safety part.

19) The apparatus according to claim 17, wherein it comprises fourth detector means for detecting insertion of the projecting element in a respective housing in the container supporting frame.

20) The apparatus according to claim 19, wherein the fourth detector means comprise at least a second presence sensor located on the projecting element and designed to engage with a wall of the housing to indicate the presence of the projecting element in the housing.

21) The apparatus according to claim 1, wherein it comprises means by which the supporting frame makes contact with the mobile body.

22) The apparatus according to claim 21, in which the container supporting frame comprises at least one crosspiece, wherein the housings for the projecting elements are at least partly made in the crosspiece, and wherein the contact means comprise at least one contact element, fixed to the mobile body and projecting from it to engage in contact with the crosspiece, in at least one container movement step.

23) The apparatus according to claim 22, wherein the contact element comprises a portion made of a material with a high friction coefficient, this portion being designed to engage with a respective portion of the crosspiece, of which there is at least one.

24) The apparatus according to claim 1, wherein it comprises three projecting elements, at least two of which are mobile projecting elements.

25) The apparatus according to claim 24, wherein the three projecting elements are arranged in such a way that they are not aligned with one another.
